(19) United States
(12) Patent Application Publication
(10) Pub. No.: US 2007/0178016 A1
(43) Pub. Date: Aug. 2, 2007

(54) Device for conveying or examining liquids

(76) Inventor: Friedrich Jost, Zug (CH)

Correspondence Address: NOTARO AND MICHALOS, 100 DUTCH HILL ROAD, SUITE 110, ORANGEBURG, NY, 10962-2100, US

(21) Appl. No.: 11/578,934

(22) PCT Filed: Apr. 18, 2005
(86) PCT No.: PCT/CH05/00214

§ 371 Date: Dec. 1, 2006

(30) Foreign Application Priority Data
Apr. 20, 2004 (CH) 681/04

(51) Int. Cl. B01L 3/02

(52) U.S. Cl. 422/100

(57) ABSTRACT

A device (1) for transporting or examining liquids in a system (3) for working with liquid specimens (4) that comprises an essentially horizontal working field (5) extending in an X orientation and in a Y orientation at right angles to the latter. The device (1) comprises at least one functional element (2) with at least one functional end (22), whereby said functional elements (2) are aligned essentially at right angles to the working field (5) in a Z orientation. The device (1) also comprises at least one tilting unit (8) for tiltable retention of the at least one functional element (2). An inventive device (1) is characterized in that the tilting unit (8) comprises actuators (10) for individual pointing of the functional ends (22) of the functional elements (2) in relation to a Z axis (11) perpendicular to the working field (5), and a control unit (17) to electrically drive the actuators (10), whereby each of the functional elements (2) can be tilted individually and independently of the X and Y orientation of the working field (5). The device (1) is preferably attached to a robot arm (6) intended to move the functional element (2) in at least one section (7) of the working field (5) and at least on the Z axis. In this case the control unit (17) is intended to coordinate control of the movement of the robot arm (6) and the change in position of the functional ends (22) of the functional elements (2) in relation to a Z axis (11) perpendicular to the working field (5).

The subject of the invention according to the preamble of independent claim 1 is a device to transport or examine liquids in a system for working with liquid specimens. Such systems comprise for example an essentially horizontal working field, extending in an X orientation and in a Y orientation at right angles to the latter. The device comprises at least one functional element with at least one functional end, whereby the functional elements are aligned essentially at right angles to the working field in a Z orientation. The device comprises at least one tilting unit for tiltable retention of the at least one functional element. Such a system preferably comprises at least one robot arm to which at least one inventive device is attached. Said robot arm is then implemented to move the functional element in at least one section of the working field and at least on the Z axis.

In the technical field of liquid handling, devices for aspiring and dispensing liquid specimens are known as pipettes or pipettors. Devices that can solely be used to dispense liquid specimens are usually referred to as dispensers. To automate the pipetting process of a volume smaller than 10 μl, two operations must be distinguished: the defined drawing up (aspiration) and the subsequent issuing (dispensation) of liquid specimens. Between these operations the pipette tip is usually moved by the experimenter or an automat so that the place where a liquid specimen is aspired is often different from the place where it is dispensed. Only the liquid system, consisting of a pump (e.g. a diluter in the form of a syringe pump), liquid line and end piece (pipette tip), is essential for the correctness and reproducibility of aspiration and/or dispensation.

The delivery of a liquid with a pipette tip can be performed “from the air” or by touching a surface. This surface can be the solid surface of a vessel (“on tip touch”) into which the liquid specimen is to be dispensed. It can also be the surface of a liquid to be found in this vessel (“on liquid surface”). A mixing operation following dispensation is recommendable—especially in the case of very small specimen volumes in the nanoliter or even picoliter range—to ensure even distribution of specimen volume in a reaction liquid.

Disposable tips or cast-off pipette tips very much reduce the risk of unintentional transfer of parts of specimens into a vessel (contamination). Familiar are simple throw-away tips (so-called air displacement tips) whose geometry and material are optimized for the reproducible drawing up and/or delivery of very small volumes. The use of so-called positive displacement tips, exhibiting a pump plunger on their inner side, is likewise known.

Working platforms or systems for handling liquids, such as the pipetting of liquids from containers, are known from U.S. Pat. No. 5,084,242 for instance. Devices are known from DE 101 16 642 and EP 0 206 945, for example, with which liquids can be dispensed into the wells of a microplate or pipetted from such containers. From U.S. Pat. No. 5,084,242 in particular one knows of a system with generic devices where the containers and a robot arm carrying the device can be placed in relation to one another so that liquid handling works automatically and reproducibly. Common to all devices and systems of the prior art is that the pipette tips or dispenser tips can only be moved as a function of the geometrical axes of the systems or robots that are used.

The purpose of the present invention is to provide an alternative device and/or method by which pipette tips or other longish, thin objects for transporting or examining liquids can be aligned whether attached to a robot arm or not, independently of the geometric axes of a system for working with liquid specimens and independently of the axes of motion of a robot used in such a system.

This objective is accomplished according to the characterizing part of independent claim 1 in that the tilting unit of an aforementioned device comprises actuators for individual alignment of the functional ends of the functional elements in relation to a Z axis perpendicular to the working field, and a control unit to electrically drive these actuators, so that each of the functional elements can be tilted individually and independently of the X and Y orientation of the working field. Additional, preferred features of the invention result from the dependent claims.

The advantages of the invention comprise the following facts and circumstances:

It has been shown that the accuracy with which a pipette tip, for example, can be automatically positioned at a location on a conventional working platform is insufficient to routinely and precisely approach the wells of a microplate with 1536 wells. In particular when using a number of pipette tips arranged in a line, the slightest displacement of the microplates, which can be positioned at least on a section of the working field, from the coordinate system of the robot arm becomes noticeable. In the worst case such displacements or deviations from the ideal position affect values on the X, Y and Z axes. Too great an error tolerance produces the risk that one or more pipette tips, temperature sensors or pH probes, or other longish, thin objects to be positioned in a well will be damaged by impact with the walls of the well or the surface of the microplate. Furthermore, in the event of a less than gentle collision of such an object with the microplate surface, there is the risk of losing a specimen, of contaminating adjacent specimens and the workplace. A precise approach to the wells, with no risk of accidentally contacting parts of the microplate, is consequently a basic requirement for routine working with a liquid handling system that can be used for automated examination of blood specimens for example. The inventive device allows correction of the individual positions of the pipette tips independently of the axes of motion of the pipetting robot so that the motion system of the robot and the inventive motion system of the pipette tip complement one another.

The inventive device is explained in detail in what follows with reference to schematic drawings that illustrate exemplary embodiments of the invention but do not limit its scope, said drawings showing:

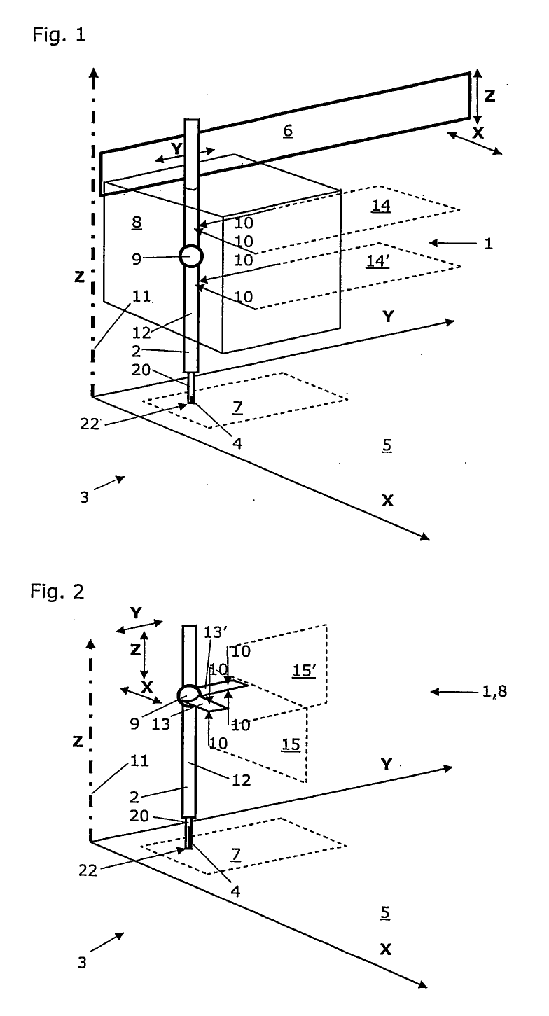

FIG. 1 a 3D scheme of a device incorporated in a liquid handling system, according to a first embodiment;

FIG. 2 a 3D scheme of a device incorporated in a liquid handling system, according to a second embodiment;

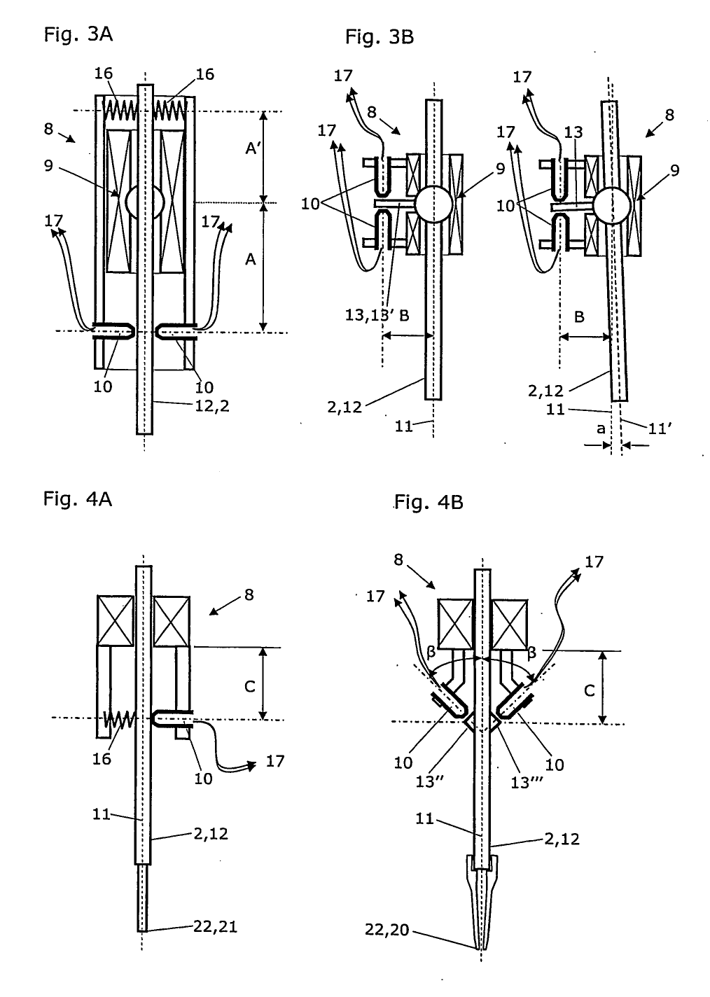

FIG. 3A a vertical section of the device incorporated in a liquid handling system, according to the first embodiment of FIG. 1;

FIG. 3B vertical sections of the device incorporated in a liquid handling system, according to the second embodiment of FIG. 2;

FIG. 4A a vertical section of a device incorporated in a liquid handling system, according to a third embodiment;

FIG. 4B a vertical section of a device incorporated in a liquid handling system, according to a fourth embodiment;

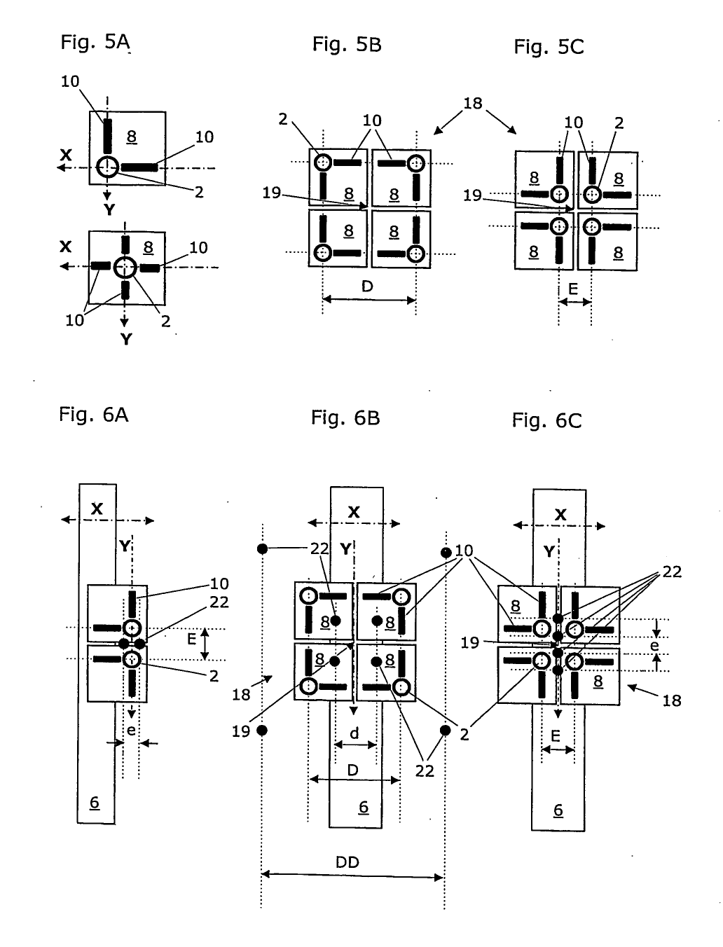

FIG. 5A two floor plan schematics of inventive tilting units;

FIG. 5B a first variant of a floor plan schematic of a quad arrangement of inventive tilting units;

FIG. 5C a second variant of a floor plan schematic of a quad arrangement of inventive tilting units;

FIG. 6A a schematic top view of a robot arm with a dual arrangement of inventive tilting units;

FIG. 6B a schematic top view of a robot arm with a quad arrangement of inventive tilting units according to FIG. 5B;

FIG. 6C a schematic top view of a robot arm with a quad arrangement of inventive tilting units according to FIG. 5C;

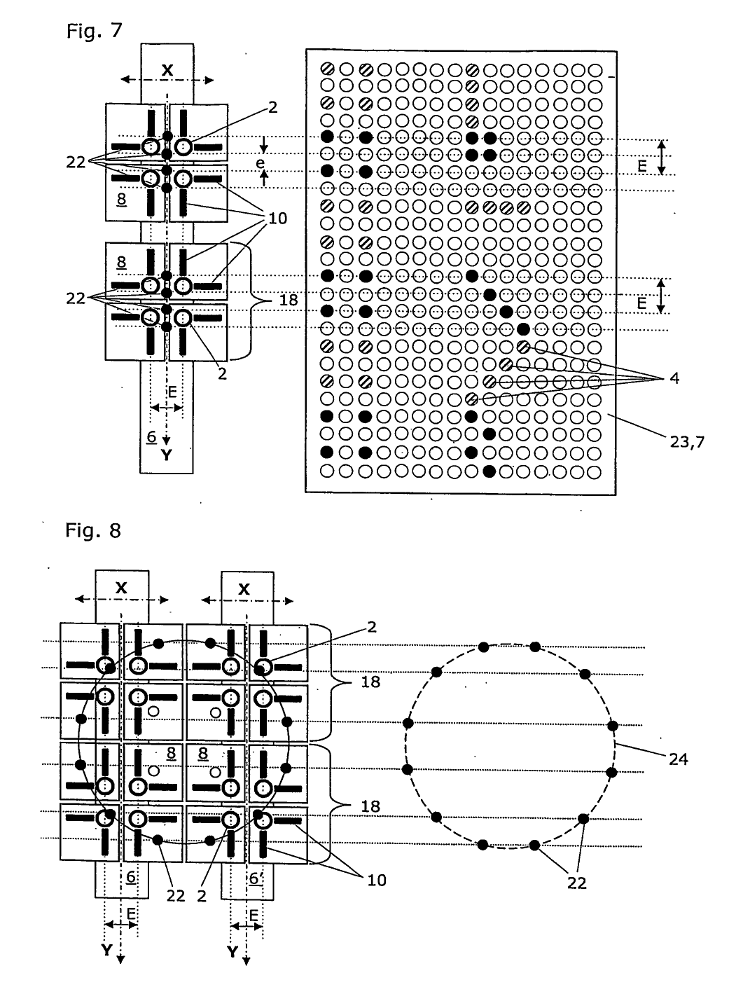

FIG. 7 a schematic top view of a robot arm with two quad arrangements of inventive tilting units according to FIG. 5C, and a top view of a microplate with 384 wells;

FIG. 8 a schematic top view of two robot arms, each with two quad arrangements of inventive tilting units according to FIG. 5C, and a top view of a working surface with a geometrical arrangement of specimens.

FIG. 1 shows a device 1 to transport or examine liquids in a system 3 for working with liquid specimens 4. The system 3 takes the form of a robotic sample processor (RSP) and comprises an essentially horizontal working field 5 and at least one robot arm 6 with its controller. Basically the working field may take any form, a round form being preferred, and a rectangular form being especially preferred.

The robot arm 6 additionally comprises at least one functional element 2 aligned essentially perpendicular to the working field 5 in a Z orientation. In conjunction with the present invention, functional elements 2 are understood to mean longish entities for specimen analysis or transport such as pipette and dispenser tips 20, or sensors 21 such as pH probes, temperature sensors and the like. Multiplepipette tips or combs, for example, are also referred to as functional elements 2.

The robot arm 6 is intended to move the functional element 2 in at least one section 7 of the working field 5 and at least in the Z direction. A single specimen test tube or a microplate with 96, 385 or 1536 wells can be called a section 7 of the working field 5. The section 7 of the working field 5 will preferably comprise several such specimen carriers as well as pickup and dropping points for throw-away pipette tips. Calibration stations (e.g. for pH probes), washing stations, waste collection points and similar logistically necessary service points will also be parts of the accessible section 7 of the working field 5.

The inventive device 1 comprises at least one tilting unit 8, moving on the robot arm 6, for tiltable retention of the at least one functional element 2. The functional ends 22 of the functional element (e.g. the pipette tip or tips of a multiple pipette or the sensor tip of a probe) play an essential role. This is because the inventive device 1 comprises actuators 10 to align said functional ends 22 of said functional elements in relation to a Z axis 11 perpendicular to the working field 5 (cf. FIG. 3B).

In the context of the present invention active elements of variable size or expansion are designated as actuators 10. Said actuators 10 preferably take the form of piezo elements that expand or contract depending on the electric voltage applied to them. Here so-called piezo stacks are especially preferred because they allow multiple expansion. The actuators 10 may also be elements like bimetals that contract and expand as a function of temperature. In their simplest form the actuators 10 may be embodied as screws for manual operation.

According to a first embodiment of the inventive device 1 (cf. FIGS. 1, 3A and 4A) said actuators 10 of a tilting unit 8 are formed so that they act directly on a shaft 12 of the functional element 2.

According to a second embodiment of the inventive device 1 (cf. FIGS. 2, 3B and 4B) said actuators 10 of a tilting unit 8 are formed so that they act indirectly on a shaft 12 of the functional element 2, i.e. through vanes 13,13′ connected to the functional element 2.

The actuators 10 of the tilting unit 8 are preferably arranged on at least one, essentially horizontal plane 14,14′, and essentially at right angles to one another to act on the shaft 12 of a functional element 2 (cf. FIGS. 1, 3A and 4A). Actuators 10 arranged in this way define an individual coordinate system that is completely independent from the axes of motion of the robot arms 6. Preferably the actuators 10 are on the same horizontal plane 14,14′ and precisely at right angles to one another to form a Cartesian coordinate system.

In its simplest embodiment the tilting unit 8 comprises a jointless holder (cf. FIG. 4) in which a functional element 2 is fixed. In a preferred embodiment the tilting unit 8 comprises a joint 9 that is arranged—preferably symmetrically—between the planes 14,14′ (cf. FIGS. 1 and 3).

The actuators 10 of a tilting unit 8 can also be arranged essentially vertically to act essentially along a Z direction on the vanes 13,13′ connected to a functional element 2 (cf. FIGS. 2 and 3B). An arrangement of the actuators as in FIG. 4B is also regarded as essentially vertical in its action on the vanes 13″,13′″. “Essentially vertical” consequently means the direction of action of the actuators 10 on the surface of the vanes 13,13′,13″,13′″ regardless of the actual orientation of the actuators 10.

All actuators 10 of a tilting unit 8 or part of these actuators 10 can also be affixed to a functional element 2 or the vanes 13 and act in the opposite direction on appropriate mating faces of the tilting unit 8 (not shown).

The actuators 10 of a tilting unit 8 are preferably arranged on two essentially vertical planes 15,15′ at right angles to one another (cf. FIGS. 2 and 5-8). Especially preferred is an arrangement in which these planes 15,15′ are parallel to the X orientation and parallel to the Y orientation of a rectangular working field 5.

According to FIGS. 1 and 2, the system 3 preferably comprises a horizontal working field 5 with a lengthwise extension X and a crosswise extension Y essentially at right angles to the latter. The robot arm 6 is specially intended to execute movements on the X and/or Y direction. In an especially preferred embodiment of the invention, the actuators 10 of the tilting unit 8 are arranged parallel to the X orientation or parallel to the Y orientation of the working field 5 so that their Cartesian coordinate system matches the X and Y orientations of the horizontal working field 5.

All actuators 10 preferably take the form of piezo elements, whereby two actuators 10 form a functional pair in which each acts against the other (cf. FIGS. 1, 2, 3B and 4B). Alternatively, an actuator 10 and a passive spring element 16 can form such a functional pair (cf. FIGS. 3A and 4A). It is also possible to utilize the elasticity of a functional element 2 or its shaft 12 to act against the actuators (not shown). In the simplest case only two actuators 10 (e.g. one in X orientation and one in Y orientation) act on a singly sided clamped functional element 2.

An inventive system 3 for working with liquid specimens 4 comprises an essentially horizontal working field 5 and at least one robot arm 6 with an associated controller. The robot arm 6 comprises at least one functional element 2 essentially perpendicular to the working field 5 in a Z orientation. The robot arm 6 is intended to move the functional element 2 in at least one section 7 of the working field 5 and at least in the Z direction. Such a system is inventively characterized in that it comprises at least one of the described devices 1 and a control unit 17 to point the functional ends 22 of the functional elements 2 in relation to a Z axis 11 perpendicular to the working field 5.

Said system 3 preferably comprises an even number of devices 1 or tilting units 8, arranged to move on the robot arm 6, preferably in groups of four (cf. FIGS. 5B, 5C; 6B, 6C; 7 and 8). Each of these groups of four devices 1 or tilting units 8 preferably takes the form of a quad unit 18 jointly moved on the robot arm 6 (cf. FIGS. 6B, 6C, 7 and 8). The functional elements 2 of each quad unit 18 are preferably arranged symmetrically about their center 19 with a large (cf. FIGS. 5B and 6B), medium (cf. FIG. 5A) or small (cf. FIGS. 5C and 6C) spacing. An especially preferred embodiment of a system 3 for working with liquid specimens 4 comprises two robot arms 6,6′ (cf. FIG. 8), each with two devices 1 and tilting units 8 arranged in quad units 18.

FIG. 1 shows a 3D schematic of a device 1 incorporated in a liquid handling system 3, according to a first embodiment. Here the liquid handling system 3 comprises a horizontal, rectangular working field 5 with a lengthwise extension X and a crosswise extension Y at right angles to the latter. The naming of these extensions is arbitrary and corresponds to the common naming of work platforms. The names of the orientations X and Y could also be changed over of course. Shown here is a tilting unit 8 that is arranged on a robot arm 6 to move on a Y direction and a Z direction perpendicular to the working field 5. The mobility of the tilting unit 8 on the Z axis can be effected (as shown) by the robot arm 6 itself or by the sliding of the tilting unit 8 on the robot arm 6. A combination of the Y motion of the tilting unit 8 and the mobility of the robot arm 6 in the X direction means that the entire working field 5, or at least a section 7 of this working field, can be worked with the functional end 22 of a functional element 2 here in the form of a pipette tip 20. In the first embodiment of the invention, the actuators 10 act directly on the shaft 12 of the functional element 2. The two horizontal planes 14,14′ on which the actuators 10 are arranged are equally spaced from the joint 9, which improves the tilting action of the functional element 2.

FIG. 2 is a 3D schematic of a device 1 incorporated in a liquid handling system 3, according to a second embodiment where the actuators 10 act on a vane 13. Unlike the horizontal orientation of the actuators in FIG. 1, here the actuators 10 are arranged vertically and act vertically on the horizontally projecting vanes 13,13′.

FIG. 3A shows a vertical section of a device 1 incorporated in a liquid handling system 3, according to the first embodiment of FIG. 1. The shaft 12 of the functional element 2, which can take the form of a metal tip or hollow needle of a pipette, is held tiltable in a joint 9. A hollow needle of this kind can be used in both a pipettor and a dispenser, so it is referred to as a pipette tip or dispenser tip. The joint 9 consists of a ball and socket. Arranged on the socket is a device that carries the actuators 10 or serves the actuators 10 as a mating face (not shown). Arranged at a spacing A from the joint 9 are piezo elements 10 that act directly on the shaft 12 of the functional element 2. The extending arrows indicate the connection of the piezo elements 10 to the control unit 17 to drive piezo activity. Arranged at a spacing A′ from the joint 9 are passive spring elements 16 that likewise act directly on the shaft 12 of the functional element 2. A sleeve (not shown) can be placed between the spring elements 16 and the shaft 12 to protect the latter. Such a sleeve can also be used to widen or level the working face of the spring elements 16, or of the actuators 10 on the shaft 12. Here the joint 9 is not symmetrical to the planes on which the actuators 10 or spring elements 16 are arranged; the distance A is larger than A′.

FIG. 3B shows vertical sections of a device 1 incorporated in a liquid handling system 3, according to the second embodiment of FIG. 2. Here too, the shaft 12 of the functional element 2 is held tiltable in a joint 9. This joint 9 also consists of a ball and socket. The socket is interrupted at least at those points where vanes 13,13′ project from the ball. Arranged on the socket is a device that carries the actuators 10. Arranged at a spacing B from the joint 9 and the vertical Z axis 11 are vertical piezo elements 10 that act on the vanes 13,13′. The extending arrows indicate the connection of the piezo elements 10 to the control unit 17 to drive piezo activity.

In the illustration on the left the functional element 2 and its shaft 12 are exactly vertical, the actuators 10 are in their off-state. What is important is that the friction of the joint ball is sufficient to prevent the position of the functional element 2 from spontaneously altering. It is also possible for the actuators 10 to permanently contribute to stabilizing this position or determining it.

In the illustration on the right the functional element 2 and its shaft 12 are tilted with respect to the Z axis 11 so that the axis 11′ of the functional element 2 and the Z axis 11 create a space (a) that is all the larger the further the functional end 22 of the functional element 2 is from the joint 9. The deflection becomes all the greater—for the same activation of the piezo elements 10—the smaller their spacing B from the Z axis is.

FIG. 4A shows a vertical section of a device 1 incorporated in a liquid handling system 3, according to a third embodiment. This third embodiment is characterized in that each functional element 2 is fixed in a holder. This holder is part of the tilting unit 8. Arranged on the holder is a device that carriers actuators 10. At a spacing C from the holder, piezo elements 10 are arranged that act directly on the shaft 12 of the functional element 2. The extending arrows indicate the connection of the piezo elements 10 to the control unit 17 to drive piezo activity. A functional pair is shown here that consists of a piezo element 10 and a passive spring element 16. The advantage of such spring elements 16 consists, among other things, in the fact that the functional element 2 is kept free of clearance. In an alternative embodiment it is possible to dispense with the spring elements 16 if the elasticity of the functional element 2 itself or its shaft 12 passively counters the applied pressure of the piezo elements. In the simplest case therefore, an elastic functional element 2 fixed in a holder is sufficient, acted on by two actuators 10 on one plane 14 and at right angles to one another (cf. FIG. 1). The shorter the distance C, the greater is the possible deflection of the functional end 22 of a functional element 2 from the Z axis 11. However, reducing the distance C increases the force that the actuators 10 must expend to move the functional element 2. The shaft 12 of the functional element 2 can be interpreted here as a temperature sensor or capillary of a metal pipette tip. The opening of this pipette tip (or dispenser tip) or the end of the temperature sensor is in this case the functional end 22 of the functional element 2.

FIG. 4B shows a vertical section of a device 1 incorporated in a liquid handling system 3, according to a fourth embodiment. This fourth embodiment is characterized in that the actuators 10 or their functional partners, likewise in the form of actuators or spring elements, are arranged neither horizontally nor vertically. They are at an angle β to the Z axis 11. This arrangement allows slimmer construction of the tilting units 8. Slimmer construction also benefits from the fact that the functional element 2 is held without a joint in a holder of the tilting unit. If an elastic functional element 2 and in all only two actuators 10 are used to tip in a Y or Z direction, the construction of a tilting unit 8 can be further reduced in size. Preferably the shaft 12 of the functional element 2 will bear vanes 13″,13′″, to one face of which the actuators 10 are applied essentially vertically. The remarks made in connection with FIG. 4A about the spacing C are also applicable here. The functional element 2 in FIG. 4B is shown as an adapter for throw-away pipette tips 20. The opening of these throw-away pipettes is the functional end 22 of the functional element 2.

FIG. 5A shows two schematic floor plans of inventive tilting units. The top schematic shows an eccentric arrangement of the functional element 2 in relation to the tilting unit 8. This arrangement is especially suitable for the use of only two actuators 10 to tilt the elastic functional element 2 in an X and Y direction. The bottom schematic shows a concentric arrangement of the functional element 2 in relation to the tilting unit 8. This arrangement is especially suitable for the use of two or four functional pairs of actuators 10 arranged on a plane 14 or 14′ (cf. FIG. 1). In fixed, elastic functional elements 2 the plane 14′ would of course be below the holding means of the tilting unit (cf. FIG. 4A). One partner of each of the functional pairs could take the form of a spring element 16.

FIG. 5B shows a first variant of a floor plan schematic of a quad arrangement 18 of inventive tilting units 8. The functional elements 2 eccentrically arranged in the tilting units 8 are distributed so that they are spaced as far as possible from the center 19 of this quad unit 18. This produces a spacing D between the axes of the untilted functional elements 2. The spacing D can be chosen so that it just corresponds to the grating of the wells of a microplate. For a 96 microplate D is 9 mm, for a 24 microplate it is double that, and for a 384 microplate it is half. Without shifting tilting units 8 in relation to one another, i.e. keeping the arrangement of the tilting units 8 as a quad unit 18, it is consequently possible to reach an adjacent quad group of wells arranged in a square in a 96 microplate and in a 24 microplate by tilting the functional elements 2 in the form of pipette tips.

FIG. 5C shows a second variant of a plan schematic of a quad arrangement 18 of inventive tilting units 8. The functional elements 2 eccentrically arranged in the tilting units 8 are distributed so that they are spaced as close as possible to the center 19 of this quad unit 18. This produces a spacing E between the axes of the untilted functional elements 2. The spacing E can be chosen so that it just corresponds to the grating of the wells of a microplate. For a 96 microplate E is 9 mm, for a 24 microplate it is double that, and for a 384 microplate it is half. Without shifting tilting units 8 in relation to one another, i.e. keeping the arrangement of the tilting units 8 as a quad unit 18, it is consequently possible to reach an adjacent quad group of wells arranged in a square in a 384 microplate and in a 96 microplate by tilting the functional elements 2 in the form of pipette tips.

FIG. 6A shows a schematic top view of a robot arm 6 moving on the X axis with a dual arrangement of inventive tilting units 8 moving on the Y axis with a spacing E between the untilted functional elements 2. Also shown (dark points) is the position of the functional ends 22 of the functional elements 2 in one possible tilting setting. The distance of the axes of these functional elements 2 is called (e) and is 4.5 mm for working 384 microplates and 2.25 mm for 1536 microplates. The dimension E, i.e. the axial spacing of the untilted functional elements 2, is preferably twice the dimension (e).

FIG. 6B shows a schematic top view of a robot arm 6 with a quad arrangement 18 of inventive tilting units 8 according to FIG. 5B. Also shown (dark points) is the position of the functional ends 22 of the functional elements 2 in two possible tilting settings. The smallest distance between the axes of the functional elements 2 is called (d) and is 4.5 mm for working 384 microplates. The biggest distance between the axes of the functional elements 2 is called (DD) and is 18 mm for working 24 microplates. In this case the distance between the axes of the untilted functional elements 2 will preferably correspond to D=9 mm.

FIG. 6C shows a schematic top view of a robot arm 6 with a quad arrangement 18 of inventive tilting units 8 according to FIG. 5C. Also shown (dark points) is the position of the functional ends 22 of the functional elements 2 in one possible tilting setting. The smallest distance between the axes of the functional elements 2 is called (e) and is 4.5 mm for working 384 microplates and 2.25 mm for 1536 microplates. In this case the distance between the axes of the untilted functional elements 2 will preferably correspond to E=9 mm or 4.5 mm.

FIG. 7 shows a schematic top view of a robot arm 6 with two quad arrangements 18 of inventive tilting units 8 according to FIG. 5C, and a plan view of a microplate with 384 wells. The possible movements of the robot arm 6 and the quad units 18 are indicated by the arrows X and Y. This microplate represents on the one hand an array 23 of specimen containers or wells; on the other hand—in order to work with only one microplate—it is to be regarded as a section 7 of the working field 5. Corresponding to the tilting of the functional elements 2 already spoken of in FIG. 6C, the functional ends 22 of the functional elements 2 are arranged along the Y orientation of the robot arm 6.

Entered in the array 23 of the microplate are sample patterns of processed wells. The same color of quad groups indicates possible repipetting of the liquid specimens 4 from a first square arrangement (left, corresponding to the distance between axes E of a 96 microplate) to practically any second arrangement (right) in the 384 microplate with a distance between axes (e). For this repipetting the robot arm 6 and/or the microplate must be moved in relation to one another in the X and Z orientations; but the quad units 18 do not alter their position on the Y axis in relation to the robot arm 6 nor in relation to the microplate. Preferably the two quad units 18 can be moved independently of one another in the Y direction on the robot arm 6. The necessary drives for moving the robot arm 6 and quad units 18 are not shown here, likewise the controller or control unit 17 that is to be used.

FIG. 8 shows a schematic top view of two robot arms 6,6′, each with two quad arrangements 18 of inventive tilting units 8 according to FIG. 5C, and a top view of a working surface with a geometric arrangement of specimens. This working surface can be defined by an arrangement of specimen test tubes for centrifugation or by a so-called LAB CD® (registered trademark of the applicant), i.e. a round disk with microchannels for processing liquid specimens. According to the arrangement of the centrifuge tubes or the filling orifices of the LAB CD®, the arrangement of the functional ends 22 of the functional elements 2 can adopt the geometrical figure of a circle or any other geometrical distribution.

Distributions of the functional ends 22 of these functional elements 2, simply exemplified in FIG. 6 through 8 and by no means treated in full, that are so independent of the axes of motion of the robot arms 6,6′ can only be implemented by using the inventive device 1 or the inventive tilting units 8.

The tilting of all functional elements 2 carried by one or two robot arms 6 is preferably coordinated. A control unit 17 is preferably used for this purpose, which coordinates control of the movement of the robot arms 6,6′ and the change in position of the functional ends 22 of the functional elements 2 in relation to a Z axis 11 perpendicular to the working field 5.

Differing to what has been said about the invention up to this point, an especially preferred implementation foresees embodiment of the device 1 for transporting or examining liquids in a system 3 for working with liquid specimens 4. Such a system comprises an essentially horizontal working field 5, extending in an X orientation and in a Y orientation at right angles to the latter. The especially preferred, inventive device 1 comprises at least one functional element 2 with at least one functional end 22. The functional elements 2 are aligned essentially at right angles to the working field 5 in a Z orientation, and the device 1 comprises at least one tilting unit 8 for tiltable retention of the at least one functional element 2. This especially preferred embodiment is characterized in that the device 1 comprises actuators 10 for individual pointing of the functional ends 22 of the functional elements 2 in relation to a Z axis 11 perpendicular to the working field 5, and a control unit 17 to electrically drive the actuators 10, whereby each of the functional elements 2 can be tilted individually and independently of the X and Y orientation of the working field 5. Optionally, one or more of these devices can also be attached to one or more robot arms 6,6′.

In such a system, featuring one or more devices 1 to transport or examine liquids but without a robot arm 6 to move said devices, preferably first the liquid containers are moved in X and/or Y direction into the immediate vicinity of the devices 1. This can be performed manually or be automated. Then the functional ends 22 of the functional elements 2 are individually tilted to point them to the position of the liquid containers (e.g. certain wells of a microplate). To pipette off the liquids, the liquid containers are raised until the functional ends 22 of the functional elements 2 immerse in the containers. To dispense liquids into the liquid containers, the containers are only raised until the functional ends 22 of the functional elements 2 do not yet immerse in the containers.

The reference numbers point to particular attributes, even if they are not expressly referred to in every case. Random combination of the items of the different embodiments is inherent to the present invention.

1. Device (1) to transport or examine liquids in a system (3) for working with liquid specimens (4) comprising an essentially horizontal working field (5) extending in an X orientation and in a Y orientation at right angles to the latter, said device (1) comprising at least one functional element (2) with at least one functional end (22), whereby said functional elements (2) are aligned essentially at right angles to the working field (5) in a Z orientation, and the device (1) comprises at least one tilting unit (8) for tiltable retention of the at least one functional element (2), characterized in that the tilting unit (8) comprises actuators (10) for individual alignment of the functional ends (22) of the functional elements (2) in relation to a Z axis (11) perpendicular to the working field (5), and a control unit (17) to electrically drive these actuators (10), so that each of the functional elements (2) can be tilted individually and independently of the X and Y orientation of the working field (5).

2. Device (1) according to claim 1, characterized in that it is attached to a robot arm (6) that is implemented to move the functional element (2) in at least one section (7) of the working field (5) and at least in the Z orientation, whereby the control unit (17) is implemented to coordinate the motion control of the robot arm (6) and the change in position of the functional ends (22) of the functional elements (2) in relation to a Z axis (11) perpendicular to the working field (5).

3. Device (1) according to claim 1, characterized in that the actuators (10) of the tilting unit (8) are designed to act on a shaft (12) of the functional element (2) and/or on vanes (13,13′) connected to the functional element (2).

4. Device (1) according to claim 3, characterized in that the actuators (10) of the tilting unit (8) are arranged on at least one, essentially horizontal plane (14,14′), and essentially at right angles to one another to act on the shaft (12) of a functional element (2).

5. Device (1) according to claim 4, characterized in that the tilting unit (8) comprises a joint (9) arranged—preferably symmetrically—between the planes (14,14′).

6. Device (1) according to claim 3, characterized in that the actuators (10) of the tilting unit (8) are arranged essentially vertically to act essentially in the Z orientation on the vanes (13,13′) connected to a functional element (2).

7. Device (1) according to claim 6, characterized in that the actuators (10) of the tilting unit (8) are arranged on two essentially vertical planes (15,15′) at right angles to one another.

8. Device (1) according to claim 7, characterized in that the planes (15,15′) are arranged parallel to the X orientation or parallel to the Y orientation of the working field (5).

9. Device (1) according to claim 6, characterized in that the tilting unit (8) comprises a joint (9) arranged—preferably symmetrically—at the level of the vanes (13,13′).

10. Device (1) according to claim 1, characterized in that all actuators (10) take the form of piezo elements with two actuators (10) forming a functional pair in which each acts against the other.

11. Device (1) according to claim 1, characterized in that an actuator (10) in the form of a piezo element and a passive spring element (16) always form a functional pair in which each acts against the other.

12. Device (1) according to claim 1, characterized in that the functional elements (2) take the form of pipette tips, dispenser tips (20) or sensors (21).

13. System (3) for working with liquid specimens (4) comprising an essentially horizontal working field (5) extending in an X orientation and a Y orientation at right angles to the latter, characterized in that the system (3) comprises at least one device (1) according to claim 1.

14. System (3) according to claim 13 comprising a horizontal working field (5) with a lengthwise extension (X) and a crosswise extension (Y) essentially at right angles to the latter, and at least one robot arm (6) that is also implemented to execute movements on the X and/or Y orientation, characterized in that the actuators (10) of the tilting unit (8) are arranged parallel to the X orientation or parallel to the Y orientation of the working field (5).

15. System (3) according to claim 14, characterized in that an even number of devices (1), preferably in groups of four, are arranged to move on the robot arm (6).

16. System (3) according to claim 14, characterized in that each group of four devices (1) is a quad unit (18) that moves jointly on the robot arm (6).

17. System (3) according to claim 14, characterized in that the functional elements (2) of each quad unit (18) are arranged symmetrically about their center (19) with a large, medium or small spacing.

18. A method for using a device (1) according to claim 1 in a system (3) for working with liquid specimens (4) that comprises an essentially horizontal working field (5), extending in an X orientation and a Y orientation at right angles to the latter, said device (1) comprising at least one functional element (2) with at least one functional end (22), whereby the functional elements (2) are aligned essentially at right angles to the working field (5) on a Z axis, and the device (1) comprises at least one tilting unit (8) for tiltable retention of the at least one functional element (2), characterized in that at least one actuator (10) of a tilting unit (8) of the device (1) is electrically driven by a control unit (17), whereupon the activated actuators (10) act on the functional element (2) so that the position of the functional end (22) of this functional element (2) alters in relation to a Z axis (11), perpendicular to the working field (5), individually and independently of the X and Y orientations of the working field (5).

19. A method for using a system (3) according claim 13 for working with liquid specimens (4), whereby the system (3) comprises an essentially horizontal working field (5), at least one robot arm (6) with an associated controller and at least one device (1) according to one of the claims 1 through 12 with a functional element (2) aligned essentially perpendicular to the working field (5) in a Z orientation, and the robot arm (6) is implemented to move the functional element (2) in at least one section (7) of the working field (5) and at least in the Z orientation, characterized in that at least one actuator (10) of a tilting unit (8) of said device (1) is electrically driven by a control unit (17), whereupon the activated actuators (10) act on the functional element (2) so that the position of the functional end (22) of this functional element (2) alters in relation to a Z axis (11), perpendicular to the working field (5), individually and independently of the axes of motion of the robot arm (6).

20. A method according to claim 18, characterized in that the tilting of all functional elements (2) carried by one or two robot arms (6) is coordinated, whereby the control unit (17) is implemented to coordinate the motion control of the robot arms (6) and the change in position of the functional ends (22) of the functional elements (2) in relation to a Z axis (11) perpendicular to the working field (5).

21. A method according to claim 18, whereby the functional elements (2) take the form of pipette or dispenser tips (20) or sensors (21), characterized in that the functional ends (22) of the functional elements (2) are arranged in an array (23) or some other geometrical figure (24).

22. A method according to claim 18, whereby the functional elements (2) take the form of pipette or dispenser tips (20) or sensors (21), characterized in that the functional ends (22) of the functional elements (2) adopt a geometrical distribution corresponding to the arrangement of certain liquid containers or filling orifices.
